(19) United States
(12) Patent Application Publication
(10) Pub. No.: US 2013/0147085 A1
(43) Pub. Date: Jun. 13, 2013

(54) ONE STEP PRODUCTION OF POLYVINYL CHLORIDE

(71) Applicants: Xiyun Serene Fan, Newark, DE (US); Michael Joseph Molitor, Wilmington, DE (US)

(72) Inventors: Xiyun Serene Fan, Newark, DE (US); Michael Joseph Molitor, Wilmington, DE (US)

(73) Assignee: E.I. DU PONT DE NEMOURS AND COMPANY, Wilmington, DE (US)

(21) Appl. No.: 13/315,641

(22) Filed: Dec. 9, 2011

(51) Int. Cl. B29B 9/06

(52) U.S. Cl. 264/141

(57) ABSTRACT

Disclosed is an extrusion process for improving heat extortion temperature of a PVC in which the process is a one-step process comprising introducing an imidized acrylic resin and an ethylene copolymer into a back feeding device of an extruder; feeding a PVC resin into the extruder; producing a mixture comprising the imidized acrylic resin, the ethylene copolymer, and the PVC resin; extruding the mixture through a die to an extrudate; and optionally pelletizing the extrudate into pellets wherein the location for feeding the PVC is at about ¼ to ¾ of the length of the extruder, measured from the die.

The invention relates to a one step process for producing a polyvinyl chloride composition having high heat distortion temperature.

### BACKGROUND OF THE INVENTION

Polyvinyl chloride (PVC) has numerous applications, including components for the construction industry such as house sidings and window frames, water pipes, toys, and various household articles. PVC is a hard and brittle resin and normally is not used as such but is compounded with processing aids, plasticizing polymers, liquid plasticizers, stabilizers, or combinations of two or more thereof, which improve its processability and performance. Uncompounded PVC has a heat distortion temperature (HDT) of about 80° C., but commercially available compounded rigid PVC has an HDT of only about 60-70° C. Some articles where rigid PVC either is or could be used, such as building components and appliance and computer housings may subject to intense heat caused by their exposure to the sun or by the operation of the equipment housed therein. It is, therefore, desirable to increase the HDT of compounded PVC resins.

PVC offers a considerable price advantage over other engineering resins, but its use as a structural material has been rather limited because of its low HDT. Methods of increasing its HDT frequently also lower its impact resistance below acceptable limits. It is also desirable to increase the HDT of PVC without substantially lowering its impact resistance.

One may add an incompatible resin (with PVC) having a sufficiently high glass transition temperature (Tg), for example, higher than 130° C. and a flexural modulus of more than about 690 MPa. Such resin can be a polycarbonate or a polysulfone resin. Inorganic filler, e.g., glass fiber, glass bead, titanium dioxide particle, or combinations of two or more thereof can also be included. Addition of inorganic fillers may rapidly increase the melt viscosity of the resulting composition which may become less or (difficultly) melt processable. The maximum HDT attained in this manner is about 80° C., the same HDT as uncompounded PVC.

One may also add a miscible resin (with PVC) having a sufficiently high Tg and flexural modulus result in compositions having an HDT higher than 80° C.

U.S. Pat. No. 5,502,111 discloses a two-step process for the manufacturing a PVC composition process comprising (1) pre-blending an imidized acrylic resin and a third polymer to produce a two-phase blend having a dispersed phase dispersed in a matrix polymer; and then (2) melt-blending the two-phase blend with PVC at a temperature of about 150-220° C. to produce a PVC composition. The PVC composition is melt-processable below about 220° C. The entire disclosure of U.S. Pat. No. 5,502,111 is incorporated herein by reference.

The concentration of the imidized acrylic resin, present as dispersed phase, in the binary blend is about 30-85 weight %. The imidized acrylic resin has a glass transition temperature above 130° C. and a flexural modulus of at least 690 kPa. The concentration of the third polymer, present as matrix (continuous phase) for the dispersed imidized acrylic resin, in the binary blend is about 15-70 weight %. The third polymer can be an ethylene terpolymer such as ELVALOY®PTW (ethylene butylacrylate methacrylate terpolymer).

In the second step, the PVC (to a final concentration of about 50-95 parts by weight) is blended with a complementary amount of the binary blend, the total adding to 100 parts by weight.

This above-disclosed first step requires use of a set of stringent extrusion conditions, and the extrusion rate has to be low. The second step is to compound the PVC resin with the binary blend resin in an extruder at a temperature of 150° C-220° C. to generate a homogeneous miscible blend of PVC and imidized acrylic resin. Accordingly, under these conditions the extruded strand appeared very rough.

This two-step process requires that a binary blend be made and the two extrusion runs thereby make the process inconvenient to industry practice.

Therefore, it is desirable to develop a much simplified process that produces a PVC compound having an improved HDT substantially the same as, or slightly better than, the highest HDT PVC ever produced by the two-step process.

### SUMMARY OF THE INVENTION

A one-step extrusion process comprises, consist essentially of, or consists of, introducing an imidized acrylic resin and an ethylene copolymer into a back feeding device of an extruder; mixing and melting the imidized acrylic resin and an ethylene copolymer to produce a blend; feeding PVC resin into the extruder; mixing and melting the blend and the PVC resin to produce a mixture; extruding the mixture through a die to an extrudate; and optionally pelletizing the extrudate into pellets wherein the die is at the front of the extruder; the feeding PVC is carried out at a location downstream to the back feeding device; and the location is at about ¼ to ¾ of the length of the extruder, measured from the back feeding device.

The pellets can be optionally converted to a shaped article including film or sheet or molded article.

### DETAILED DESCRIPTION OF THE INVENTION

Any extruder known to one skilled in the art can be used. It is preferably a twin screw extruder, can have any length, any number of barrels, and any barrel size known to one skilled in the art. The screws can be any convenient design known to one skilled in the art such as mixing screws, corotating screws, or Buss kneader screws. An extruder is well known to one skilled in the art, the description of which is omitted herein for the interest of brevity.

The extruder has a back loading device to feed an imidized acrylic resin and an ethylene copolymer and has a side feeding device at which a PVC resin is introduced to the extruder and to form a melt blend with the imidized acrylic resin and the ethylene copolymer. The side feeding device can be downstream to the back loading device and can be one quarter or about three quarters of the extruder length, measured from the back loading device. For example, the location for feeding PVC to the extruder can be at about ¼ to ¾, about ⅓ to ¾, or about ½ to ⅔ of the length of the extruder, measured from the back feeding device.

Beginning with the back feeding device and ending with the extrusion die, the extruder can have different barrels or zones or numbers of barrels or zones at which a suitable temperatures can be maintained. For example, the extruder temperature can be set at about 170° C. to about 220° C., or about 180° C. to about 210° C. At or immediately following the back feeding device a temperature can be as low as about 130-160° C. The temperature at the die can be set at about 170° C-230° C. or 160-190° C. Shearing in the extruder produces heat and, therefore, the melt temperature can be higher than any set temperature and may reach, as high as 230° C. PVC may degrade at temperature higher than 230° C. or as high as 240° C.

Between the back feeding device and the side feeding device, there is preferably at least one kneading block or are at least two kneading blocks. It is also preferably that there is at least one kneading block or are at least two kneading blocks between the PVC side feeding device and the die. The kneading block can have block thickness of 0.001 to about 5 inches, 0.01 to about 3 inches, or 0.1 to about 2 inches, depending on the size of the barrels, the screws, and the extruder itself. The kneading blocks can be forward (right-handed), neutral, or backward (left-handed or reverse) blocks to provide proper shear and mixing of the ingredients.

An imidized acrylic resin can be obtained by treating an acrylic polymer with ammonia or a monoalkyl amine wherein the monoalkyl group has from one to five carbon atoms, the degree of imidization is 20% to 100% and the acid level is from 0 to 10 weight % of the imidized acrylic resin. An imidized acrylic resin can also be obtained by treating polymethyl methacrylate with a monoalkyl amine, more preferably methyl amine. Also preferably the imidized acrylic resin comprises cyclic imide units. Detailed description of a process for making an imidized acrylic resin is disclosed in U.S. application Ser. No. 12/500770, the disclosure of which is incorporated herein by reference.

For example, an imidized acrylic resin, as disclosed in U.S. Pat. No. 5,502,111, can be produced by reacting a poly(alkyl alkylacrylate) with ammonia or with an organic amine. A poly(alkyl alkylacrylate) can include such as poly(methyl methacrylate), polyacrylates, or polymethacrylate. An amine can include such as, for example, methylamine, ethylamine, isopropylamine, butylamine, dodecylamine, cyclohexylamine, aniline, even higher aliphatic or cycloaliphatic amine, aniline, methylphenylamine, or aromatic amine. The molecular weight of the imidized acrylic resins can be 10000 to 250000, 20000 to 200000, or 50000 to 150000. The degree of imidization can be 20-60% or 60-100%. The acrylic resin can contain a small amount, such as 0.001 to 20 (based on the weight of the acrylic resin) of repeat units derived from a comonomer such additional styrene, acrylonitrile, vinyl acetate, methyl vinyl ether, or ethyl vinyl ether. Example of imidized acrylic resins can be obtained from Rohm & Haas in Philadelphia, Pa., USA. An imidized acrylic resin commercially available from Rohm & Haas is polyglutarimide (imidized acrylic resins, imides of polyacrylic acids) as disclosed in U.S. Pat. No. 4,255,322, disclosure of which is incorporated herein by reference. Other commercially available imidized acrylic resin includes PARALOID®EXL-4000, PARALOID®EXL-4261, and PARALOID®EXL-4171.

An ethylene copolymer can comprise, consist essentially of, or consist of, repeat units derived from ethylene and a comonomer such as alky (meth)acrylate, epoxide alky (meth)acrylate, vinyl acetate, epoxide vinyl ester, (meth)acrylic acid, completely or partially neutralized (meth)acrylic acid, or combinations of two or more thereof. An ethylene copolymer may comprise up to 35 wt % of an additional comonomer such as carbon monoxide, sulfur dioxide, acrylonitrile, maleic anhydride, dimethyl maleate, diethyl maleate, dibutyl maleate, dimethyl fumarate, diethyl fumarate, dibutyl fumarate, dimenthyl fumarate, maleic acid, maleic acid monoesters, itaconic acid, fumaric acid, fumaric acid monoester, or a salt of any of these acids. An epoxide alky (meth)acrylate can be glycidyl acrylate, or glycidyl methacrylate. An epoxide vinyl ester can be glycidyl vinyl ether, where the ester can be one or more C₁ to C₄ alcohols (e.g., methyl, ethyl, n-propyl, isopropyl and n-butyl alcohols), combinations of two or more thereof.

The ethylene copolymers are well known to one skilled in the art and the description of which is omitted herein for the interest of brevity. For examples, ethylene alky (meth)acrylate copolymers include ethylene acrylate, ethylene methyl acrylate, ethylene ethyl acrylate, ethylene butyl acrylate, ethylene n-butyl acrylate carbon monoxide (ENBACO), ethylene glycidyl methacrylate (EBAGMA), or combinations of two or more thereof such as ELVALOY® commercially available from E. I. du Pont de Nemours and Company, Wilmington, Del. (DuPont). A mixture of two or more different ethylene alkyl (meth)acrylate copolymers can be used.

Example of ethylene vinyl acetate (EVA) copolymer also includes ethylene/vinyl acetate/carbon monoxide (EVACO). EVA may be modified by methods well known in the art, including modification with an unsaturated carboxylic acid or its derivatives, such as maleic anhydride or maleic acid. Commercially available EVA includes ELVAX® from DuPont.

Any PVC known to one skilled in the art and commercially available can be used. A usual commercial PVC resin contains processing aids, plasticizers, stabilizers, and possibly other additives, the amount of PVC in commercial rigid PVC resin always can be less than 100%.

PVC can be made softer and more flexible by the addition of a plasticizer. Any plasticizers that can be used with PVC include phthalate-based plasticizers, adipate—based plasticizers, trimellitates, maleates, sebacates, benzoatesm epoxidized oils, sulfonamides, organophosphates, or polyethers,

Different forms of PVC are used in different applications. One property is the mean molecular weight of the polymer. A factor known as the K value is used to indicate the mean molecular weight of polyvinyl chloride. The K value is the viscosity of a 0.005 weight % solution of the PVC in cyclohexanone at 25° C. as measured using an Ubbelhode viscometer. The K value is the German standard DIN 53726. Typically the higher the K value the better the mechanical properties but the lower the flowability. Preferably a PVC resin has a Filentscher K-value of from about 50 to about 70, or from about 55 to about 65.

A phthalate-based plasticizer is frequently used with PVC and can include butyl octyl phthalate, hexyl decyl phthalate, di-n-hexyl azelate, dibutyl phthalate, dibutoxy ethyl phthalate, butyl benzyl phthalate, butyl octyl phthalate, dihexyl phthalate, dioctyl phthalate, diisooctyl phthalate, dicapryl phthalate, dicapryldioctyl phthalate, diisononyl phthalate, diisodecyl phthalate, ditridecyl phthalate, any plasticizer known to one skilled in the art of flexible PVC, or combinations of two or more thereof.

The PVC employed herein is rigid PVC and preferably does not contain a plasticizer.

The compositions can additionally comprise additives used in polymer compositions including heat stabilizer, viscosity stabilizer, hydrolytic stabilizer, antioxidant, UV stabilizer, anti-static agent, dye, pigment or other coloring agent, inorganic filler, fire-retardant, lubricant, reinforcing agent such as glass fiber and flakes, foaming or blowing agent, processing aid, delustrant such as TiO₂, antiblock agent, release agent, or combinations of two or more thereof.

Inorganic filler comprises particles of inorganic compounds, such as minerals and salts such as CaCO₃.

Foaming or blowing agents known to one skilled in the art can be incorporated to reduce the density of the PVC composition and also to size the product to the required dimensions in an extrusion process. Examples of solid blowing agents include monosodium citrate, sodium bicarbonate, or combinations thereof.

Heat stabilizer includes a calcium/phosphate derivative of a hindered phenol sold under the trademark RECYCLOSTAB 411 (calcium phosphate) by Ciba-Geigy Chemicals (Tarrytown, N.Y.). The heat stabilizer can also be one or more hydroxyamines, phenols, phosphates, and metal soaps. In the case where the thermoplastic polymer of the composite is polyvinyl chloride or polyvinyl chloride copolymer, conventional polyvinyl chloride stabilizers, well known in the art, may also be used.

Antioxidant includes alkylated phenols and bis-phenols such as hindered phenols, polyphenols, thio and di-thio polyalkylated phenols, lactones such as 3-arylbenzofuran-2-one and hydroxyl-amine as well as Vitamin E.

Reinforcing agent such as glass fiber, polyester fabric, scrim, coated fabric, and flakes can be used to improve flex modulus of the PVC composition.

For every 100 parts of PVC by weight, the plasticizer, filler, or additive can be present in the composition in the range of from about 30 to about 150, about 45 to about 125 or about 60 to about 100 parts and one or more additives can be presenting the composition from about 1 to about 50, about 2 to about 25, or about 3 to about 10 parts.

The final PVC product or a composition or article thereof can exhibit an HDT temperature determined according to ASTM D648 in the range of 60 to 100° C., depending on the concentration of imidized acrylic resin is present in the composition. For example, the HDT can be in the range of 60 to 95° C. with 24%, or higher, of imidized acrylic resin, with or without annealing of the final PVC product.

Also disclosed is an article made from the product made by the invention process. For example, the product can be used in or as wood composite, construction or building material (such as roofing membrane, decking, or railing), and many other applications in construction, window profile, door frame, siding, pipes, home compliances, computer housing, office machine housing, and the like.

Further disclosed is a process for producing a compounded PVC having improved heat distortion temperature. The process comprising, consisting essentially of, or consisting of, introducing an imidized acrylic resin and an ethylene copolymer into a back feeding device of an extruder; mixing and melting the imidized acrylic resin and an ethylene copolymer to produce a blend; feeding PVC resin into the extruder; mixing and melting the blend and the PVC resin to produce a mixture; extruding the mixture through a die to produce a compounded PVC; and optionally pelletizing the compounded PVC into pellets. The process is carried out under a condition effective to produce the compounded PVC having an HDT that is at least 10° C. higher, at least 15° C. higher, at least 20° C. higher, or even at least 25° C. higher than the original PVC resin depending on the weight % of imidized acrylic resin, ranging from 10 to about 25 weight %. Generally, every 1% inclusion of the imidized acrylic resin may increase about 1° C. The extruder design and the process can be the same or substantially the same as the process disclosed above.

### EXAMPLES

PLEXIGLAS® V920 was a PMMA (poly(methylmethacrylate)) resin with melt flow rate of 8.0 g/10 min, measured according to ASTM D1238 at 230° C. using a 3.8 kg weight.

Test Methods

Nitrogen number as a weight % of nitrogen of the imidized acrylic polymer was determined by a standard combustion method using a CHN analyzer, Carlo Erba Model 1108. The % (by weight) imidization of the polymer was calculated based on the nitrogen number (the nitrogen number for a 100% imidized PMMA resin is 8.4).

Weight % of methacrylic acid in the imidized acrylic polymer was determined by titration and calculating the amount of methacrylic acid from the molar amount of acid neutralized. The weight % of ester groups can be calculated by subtracting the imide weight % and the acid weight % from 100. The amount of anhydride was assumed to be negligible, since anhydride could not be detected by IR.

HDT was determined in each case at 264 psi (1820 kPa) according to ASTM D-648. Flexural modulus was determined according to ASTM D-790. Notched Izod impact strength was determined according to ASTM D-256.

The imidized acrylic imidized acrylic-1 used was a product of PMMA imidized with monomethylamine. A 25-mm diameter single screw extruder was used to melt and meter the starting PMMA resin into a 15-meter long, 12.5-mm diameter stainless steel transfer line tube. A polymer valve at the end of the transfer line was used to regulate the pressure in the transfer line. Downstream from the polymer valve was a 25-mm twin screw extruder with two vacuum vent ports used to remove excess amine and reaction byproducts prior to pumping the polymer through a strand die and cutting the strand into pellets. The amine source was injected into the polymer melt at the start of the transfer line using dual syringe pump system. After an imidized acrylic was made and the volatiles were removed in the twin-screw extruder, the imidized acrylic product contained carboxylic acid groups, anhydride groups, and some unreacted esters in addition to the imide groups. The initially-prepared imidized acrylic may typically have 5 or more weight % of acid groups. “Low Acid” versions of imidized acrylic are produced by running the originally produced imidized acrylic back into an extruder a second time and adding dimethyl carbonate to esterify the acid groups on the polymer chain.

The imidized acrylic-1 samples were made by reacting PLEXIGLAS® V920 PMMA with monomethylamine using a screw speed on the single screw extruder of 50 rpms that was estimated to correspond to a PMMA resin feed rate of 97 g/minute and monomethylamine injection rate of 43 ml/minute. The oil temperature set-point for the jacket around the transfer line was 280° C., polymer melt temperature readings were 260° C. The pressure at the discharge to the polymer valve was controlled to 800 to 900 psig (5.5 to 6.2 mPa). The methyl amine injection pressure was recorded as 900 to 1200 psig (6.2 to 8.3 mPa). In the twin screw extruder the vacuum at the vent ports was recorded as being 17 in Hg or 58 kPa. The melt temperature of the polymer recorded at the pelletizing die of the twin screw extruder was 245° C. By DSC and nitrogen analysis it was determined the Tg was 163° C. and the nitrogen content was 7.5 weight %. Several small batches run under the same nominal conditions were blended together to provide the high acid imidized acrylic.

The low acid imidized acrylic-1 used in the following tests was made by re-extruding the dried high acid material (dried overnight at 100° C. set-point in a desiccant hopper dryer) made under the nominal conditions described above and treating with dimethyl carbonate. The single screw extruder screw speed was 74 rpm which was estimated to correspond to a feed rate of 140 g/min. The syringe pump was filled with dimethyl carbonate and injected into the transfer line at a rate of 14 ml/min to reduce the amount of acid present in the polymer. The set-point on the oil heater heating the oil jacketing the transfer line was set to 280° C. The discharge pressure at the end of the transfer line was controlled to 250 to 440 psig (1.7 to 3 mPa). The syringe pump injection pressure was 640 to 880 psig (4.4 to 6 mPa). The melt temperature of high acid polymer recorded at the adapter between the single screw extruder and the transfer line was 270° C. The melt temperature of the low acid imidized acrylic at the pelletizing die of the twin screw extruder was 235 to 265° C. By DSC and Nitrogen analysis it was determined the Tg of the low acid material was 151° C. and the Nitrogen content was 7.5 weight %. Several small batches were blended together to provide the low acid imidized acrylic-1. The aggregate blends of the small batches of imidized acrylics were reanalyzed, with the results summarized in Table A (imidized acrylic or IA denotes of imidized acrylic resin; HA denotes high acid; LA denotes low acid; and LA-2 (HDT3-2A) was used as HDT3).

TABLE A

| | Nitrogen | | | |
|---|---|---|---|---|
| | Number | % Imide | % Acid | Tg (° C.) |
| IA-HA-1 (167-1N) | 8.0 | 95 | 6.92 | 168 |
| IA-LA-1 (167-2) | 7.8 | 93 | 0.5 | 155 |
| IA-LA-2 (HDT3-2A) | 7.8 | 93 | 0.38 | 152 |
| IA-LA-3 (HDT3-1) | 7.5 | 89 | 0.17 | 150 |

### Comparative Example C1

Comparative Examples C1 was carried out in a one step process. In Comparative Example C1, neat PVC (PVC-1; obtained from CCC Plastics (Purdy Road, P.O. Box 10, Colborne, Ontario, Canada, k0k 1S0) and had a K value of 60.) was used. The extruder barrel temperature control was about 185° C. (except for the rear barrel or zone which was 175° C.). The PVC extrudate, cut to pellets, was injection molded into standard test bars. The mold temperature was 20° C.

### Comparative Example C2 Two-Step Process

Comparative Example 2 employed the known process disclosed in U.S. Pat. No. 5,502,111. In Comparative Example C2, IA-1 (IA-LA-2 (HDT3-2A) in Table A) and an ethylene butyl acrylate glycidyl methacrylate terpolymer (EBAGMA; ELVALOY® PTW obtained from DuPont; it had a melting point of 72° C., Tg of −55° C., melt flow rate of 12 g/10 min, measured according to ASTM D1238 at 190° C. using a 2.16 kg weight, and a density 0.94 g/cm³) were compounded to produce a binary blend in a first extruder. The binary blend was then compounded with PVC-1 to produce a product having an improved HDT. The extrudate, cut into pellets, was injection molded into standard test plaques

### Example 1 One-Step Process

The 1-step process is described as follows.

PVC was also from obtained CCC Plastics and had a K value of 60.

IA-LA-2 (HDT3-2A) was an imidized acrylic resin, which was a product of PMMA imidized with monomethylamine and was produced from a DuPont laboratory in Kingston, Ontario, Canada. Ethylene copolymer used was also a terpolymer ENBAGMA (ELVALOY®PTW from DuPont).

An 18 mm twin-screw extruder having 10 barrels was used. Total length of the extruder was 720 mm. The extruder was fed using 3 separate loss in weight K-Tron feeders. Two feeders were used to feed the imidized acrylic resin and the ethylene copolymer in the main feed barrel. The feeding device located at about 36 mm of the extruder. The two ingredients, the imidized acrylic resin HDT3 and ethylene copolymer ENBAGMA were fed through these two separate feeders into the same hopper at feed rates of, respectively, 4.32 pph (pounds per hour) and 1.08 pph with a total feed rate of 5.4 pph.

A third feeder was used to feed PVC into the side feeder stuffer which then fed resin into a down stream barrel at about 300 mm (or about 420 mm from the die) of the extruder.

PVC powder was fed down stream via the side feeder at a rate of 12.6 pph (total throughput of all polymers was 18 pph) to compound the PVC, imidized acrylic resin HDT3, and ENBAGMA in the extruder.

The barrel temperature settings were 180° C. for the first two barrels and 180 to 190° C. for the following 7 barrels. The screw speed was 150 rpm. At this set of the compounding condition, the recorded torque was 59%, the die pressure was 32 bar, and the melt temperature at the die exist measured by an hand-held thermocouple was 209 to 216° C. A screw design was made to provide the right amount of shear. In this design a set of conventional kneading blocks were added in the first half of the screw length to provide adequate amount of kneading and mixing to form a thorough binary blend. In the second half of the screw length, since it was known that PVC is very temperature sensitive, a milder set of conventional kneading blocks were used in the down stream barrel to provide the right amount of shearing and mixing to form a blend of PVC and the binary blend without overheating the polymer.

Two right handed (forward), one neutral, and one left handed (backward) kneading blocks (about one quarter inch thick) were added at about 170 mm to about 250 mm to properly kneading and mixing to form a thorough binary blend of the ethylene copolymer and the imidized acrylic resin. In the second half of the screw length, it is known that PVC is very temperature sensitive a milder set of conventional kneading blocks were used in the down stream barrel to provide the right amount of shearing and mixing to form the blend of PVC and the binary blend with out over heating the polymer. Accordingly, in the second half of the screw length, a set of 5 right handed (forward) kneading blocks (about three eighths inch) were used at about 610 to about 660 mm to provide the right amount of shearing and mixing to form the blend of PVC and the binary blend.

Under the conditions described above, uniform and smooth extrudate strand was obtained and there were no un-fused PVC gels detected. The strand was then cut into pellets. A 1.5 oz Arburg injection molding machine was used to mold the pellets into testing sample bars (same for C1 and C2 above). The injection molding melt temperature was controlled under 210° C. It was noticed that the addition of the imidized acrylic resin and the ethylene copolymer improved the mold flow as compared to the molding of the PVC neat resin (comparative example 1). The molded bars made from the invention process containing the PVC resin were smooth, and the tiger stripes that were shown on the PVC control sample were greatly reduced or essentially eliminated. Some physical data are shown below.

TABLE 1

| Example | C1 | C2 | 1 | 2 | 3 |
|---|---|---|---|---|---|
| Blending process | PVC-1 | Two-step | One-step (Invention) | | |
| Temp set points (° C.) | | | 190 | 180 | 180 |
| RPM | | | 150 | 150 | 200 |
| Number die holes | | | 2 | 2 | 2 |
| Feed rate (phh) | | | 18 | 18 | 18.2 |
| Hand melt (° C.) | | | 216 | 209 | 213 |
| HDT Annealed (° C.) at | 62 | 87.3 | 87.7 | 88.1 | 87.3 |
| 88° C. for 8 hr | | | | | |

Examples 1 to 4 each had PVC (70 pph) and mixture of imidized acrylic and ethylene copolymer.
Hand melt-PVC was melted before feeding.
HDT of C1 annealed at 70° C. was 66.7° C.
IA-LA-2 (HDT3-2A) was present at 24 weight %.

Table 1 shows that unmodified (neat) PVC had an HDT of 62° C. The PVC produced by C2 (using the two-step process disclosed in U.S. Pat. No. 5,502,111) process had an HDT of 87.3° C.

The one-step invention process (Example 1) produced a PVC having an HDT of 87.7° C. that was better than, or comparable to, the 87.3° C. HDT of the PVC product made from the known two-step process. The almost 26° C. increase in HDT (from 62° C. to 87.7° C.) at 24% imidized acrylic resin loading was comparable or slightly higher than the best results ever achieved from the two-step process (disclosed in U.S. Pat. No. 5,502,111). Moreover, all the other mechanical properties tested, including tensile strength, elongation, flexural modulus, and impact strength, are comparable or slightly better than those obtained from the two-step process (U.S. Pat. No. 5,502,111).

1. An extrusion process comprising introducing an imidized acrylic resin and an ethylene copolymer into a back feeding device of an extruder; mixing and melting the imidized acrylic resin and an ethylene copolymer to produce a blend; feeding PVC resin into the extruder; mixing and melting the blend and the PVC resin to produce a mixture; extruding the mixture through a die to an extrudate; and optionally pelletizing the extrudate into pellets wherein
the die is at the front of the extruder;
the feeding PVC is carried out at a location downstream to the back feeding device; and
the location is at about ¼ to ¾ of the length of the extruder, measured from the back feeding device.

2. The process of claim 1 wherein the feeding PVC is at about ⅓ to ¾ of the length of the extruder.

3. The process of claim 1 wherein the feeding PVC is at about ½ to ⅔ of the length of the extruder.

4. The process of claim 3 wherein, based on the total weight of the mixture, the imidized acrylic resin is present in the range from about 5 to about 40%.

5. The process of claim 4 wherein the imidized acrylic resin is present in the range from about 10 to about 30%.

6. The process of claim 4 wherein the imidized acrylic resin is present in the range from about 20 to about 26%.

7. The process of claim 5 wherein the ethylene copolymer is present in the range from about 1 to about 10%.

8. The process of claim 6 wherein the ethylene copolymer is present in the range from about 4 to about 8% and the mixture optionally further comprises an additive.

9. The process of claim 8 wherein the temperature of the extruder is about 170° C. to about 230° C.

10. The process of claim 9 wherein the imidized acrylic resin is obtained by treating an acrylic polymer with ammonia or a monoalkyl amine wherein the temperature of the extruder is about 180° C. to about 210° C.

11. The process of claim 10 wherein the imidized acrylic resin is an imide of an acrylic acid polymer.

12. The process of claim 11 wherein the acrylic resin is poly(methyl methacrylate).

13. The process of claim 11 wherein the ethylene copolymer comprises repeat units derived from ethylene and a comonomer such as alkyl (meth)acrylate, epoxide alkyl (meth)acrylate, vinyl acetate, epoxide vinyl ester, (meth)acrylic acid, completely or partially neutralized (meth)acrylic acid, or combinations of two or more thereof.

14. The process of claim 13 wherein the ethylene copolymer comprises repeat units derived from ethylene and alkyl (meth)acrylate, epoxide alkyl (meth)acrylate, or combinations thereof.

15. The process of claim 14 wherein the ethylene copolymer is a terpolymer of ethylene, butyl acrylate, and glycidyl methacrylate.

16. The process of claim 15 wherein the process comprises pelletizing the extrudate to pellets.

17. The process of claim 16 wherein the pellet is converted to a shaped article.

18. A process comprising introducing an imidized acrylic resin and an ethylene copolymer into a back feeding device of an extruder; mixing and melting the imidized acrylic resin and an ethylene copolymer to produce a blend; feeding PVC resin into the extruder; mixing and melting the blend and the PVC resin to produce a mixture; extruding the mixture through a die to produce a compounded PVC; and optionally pelletizing the compounded PVC into pellets wherein
the process is carried out under a condition such that the heat extortion temperature (HDT) of the compounded PVC is at least 10° C. higher than that of the PVC resin;
the die is at the front of the extruder;
the feeding PVC is carried out at a location downstream to the back feeding device; and
the location is at about ¼ to ¾ of the length of the extruder, measured from the back feeding device.

19. The process of claim 18 wherein the HDT that is at least 15° C. higher.

20. The process of claim 18 wherein the HDT that is at least 20° C. higher.
